(19) United States
(12) Patent Application Publication
(10) Pub. No.: US 2005/0137322 A1
(43) Pub. Date: Jun. 23, 2005

(54) Silane modified two-component polyurethane coating

(76) Inventors: Richard R. Roesler, Wexford, PA (US); Karen M. Henderson, Coraopolis, PA (US)

Correspondence Address: BAYER MATERIAL SCIENCE LLC, 100 BAYER ROAD, PITTSBURGH, PA, 15205, US

(21) Appl. No.: 10/738,725

(22) Filed: Dec. 17, 2003

(51) Int. Cl. C08K 3/00

(52) U.S. Cl. 524/589

(57) ABSTRACT

A two-component coating composition that includes (a) a first component including a compound that contains trialkoxysilyl and isocyanate functional groups; and (b) a second component that includes a polyol and a catalyst. The two component coating composition can be used in a method of coating a substrate that includes applying the coating composition to at least a portion of a surface of the substrate, thus providing a substrate coated with the above-described two-component coating composition.

### BACKGROUND OF THE INVENTION

1. Field of the Invention

The invention relates to aqueous two-component polyurethane systems, a process for their production, and their use for the production of coatings.

2. Background Art

In recent times, it has become popular to manufacture automobiles having bodies coated to provide a “wet” look. Such an appearance is typically accomplished by applying multiple coating layers, the last of which, is usually an unpigmented coating with a high gloss value. Unfortunately, as the car ages, scratches that occur through normal “wear and tear”, repeated washing and the effects of acid rain tend to deteriorate the appearance of the coated surface of the automobile body.

U.S. Pat. No. 5,369,153 to Barsotti et al. discloses a coating composition useful for a finish for automobiles and trucks in which the film forming binder includes an acrylic polymer having at least two reactive acid groups, an epoxy-containing crosslinker, a melamine resin, and an epoxy-silane modifying agent. The composition is used as a one-package system.

U.S. Pat. No. 5,204,404 to Werner et al. discloses a water-based coating composition containing 10 to 30% by weight of a film forming binder dispersed in an aqueous carrier. The binder contains an acrylic silane polymer and a polyurethane. The composition is used for painting and refinishing the exterior of automobiles and trucks.

U.S. Pat. No. 6,590,028 to Probst, et al. discloses an aqueous two-component polyurethane system, a process for their production, and their use for the production of coatings having increased impact strength, high stability properties and outstanding optical properties.

U.S. Published patent application 2003/0039846 A1 to Roesler et al. discloses a two-component coating composition containing a polyisocyanate component, an isocyanate-reactive component that contains less than 3% by weight of an aromatic polyamine and 0.1 to 1.8 wt. %, based on the weight of the other components of a compound containing at least one epoxy group and at least one alkoxysilane group.

However, heretofore known coating compositions do not provide adequate resistance to scratches in order to satisfactorily stave off the deterioration in appearance of the coated surface of an automobile or truck body. Thus, there remains a need in the art for such a coating composition.

### SUMMARY OF THE INVENTION

The present invention provides a two-component coating composition that includes:
(a) a first component including a compound that contains trialkoxysilyl and isocyanate functional groups; and
(b) a second component that includes a polyol and a catalyst.

The present invention further provides a method of coating a substrate that includes applying the above-described two-component coating composition to at least a portion of a surface of the substrate as well as substrates prepared according to the method.

The present invention is also directed to substrates coated with the above-described two-component coating composition.

### DETAILED DESCRIPTION OF THE INVENTION

Other than in the operating examples, or where otherwise indicated, all numbers or expressions referring to quantities of ingredients, reaction conditions, etc., used in the specification and claims are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations.

Embodiments of the present invention provide a two-component coating composition that includes:
(a) a first component including a compound that contains trialkoxysilyl and isocyanate functional groups; and
(b) a second component that includes a polyol and a catalyst.

In the present invention, it has been found that the addition of silane functionality to a two component polyurethane coating enhances the scratch resistance of the applied coating.

As used herein, the term “alkoxysilane groups” refers to groups having the general structure —Si—O—R², where R² is selected from C₁-C₆ linear, branched, and cyclic alkyl.

As used herein, the term “isocyanate functional groups” refers to groups having the general structure —NCO or equivalents thereof.

Embodiments of the invention provide moisture curable resins based on silane chemistry. Any suitable compound that contains trialkoxysilyl and isocyanate functional groups can be used in the present invention. In a particular embodiment, the, suitable compounds that contain trialkoxysilyl and isocyanate functional groups are the reaction products obtained from a polyisocyanate and, the reaction product of an N-(-3-trialkoxysilylalkyl)amine and a dialkyl maleate or dialkyl fumarate.

In a more particular embodiment an aspartate resin is used. As a non-limiting xample, the aspartate resin can be the reaction product of N-(3-trialkoxysilylpropyl) and diethyl maleate. The aspartate resin can then be treated with two or more equivalents of polyisocyanates to form a silane functional, isocyanate urea. The silane functional isocyanate is combined with a polyol to make a two-component coating composition.

In an embodiment of the invention, the N-(-3-trialkoxysilylalkyl)amine has a structure according to formula (I):
NH₂—R¹—Si(—O—R²)₃ (I)
where R¹ is selected from C₁-C₁₂ linear, branched and cyclic alkylene, arylene, and aralkylene; and R² is independently selected from C₁-C₆ linear, branched, and cyclic alkyl. In a particular embodiment, R¹ is selected from ethylene, propylene, and butylene and R² is selected from ethyl and propyl.

As used herein the term “alkyl” refers to a monovalent radical of an aliphatic hydrocarbon chain of general formula CₛH₂ₛ₊₁, where s is the number of carbon atoms, or ranges therefore, as specified. The term “substituted alkyl” refers to an alkyl group, where one or more hydrogens are replaced with a non-carbon atom or group, non-limiting examples of such atoms or groups include halides, amines, alcohols, oxygen (such as ketone or aldehyde groups), and thiols.

As used herein the terms “cyclic alkyl” or “cycloalkyl” refer to a monovalent radical of an aliphatic hydrocarbon chain that forms a ring of general formula CₛH₂ₛ₋₁, where s is the number of carbon atoms, or ranges therefore, as specified. The term “substituted cycloalkyl” refers to a cycloalkyl group, containing one or more hetero atoms, non-limiting examples being —O—, —NR—, and —S— in the ring structure, and/or where one or more hydrogens are replaced with a non-carbon atom or group, non-limiting examples of such atoms or groups include halides, amines, alcohols, oxygen (such as ketone or aldehyde groups), and thiols. R represents an alkyl group of from 1 to 24 carbon atoms.

As used herein, the term “aryl” refers to a monovalent radical of an aromatic hydrocarbon. Aromatic hydrocarbons include those carbon based cyclic compounds containing conjugated double bonds where 4t+2 electrons are included in the resulting cyclic conjugated pi-orbital system, where t is an integer of at least 1. As used herein, aryl groups can include single aromatic ring structures, one or more fused aromatic ring structures, covalently connected aromatic ring structures, any or all of which can include heteroatoms. Non-limiting examples of such heteroatoms that can be included in aromatic ring structures include O, N, and S.

As used herein, the term “alkylene” refers to acyclic or cyclic divalent hydrocarbons having a carbon chain length of from C₁ (in the case of acyclic) or C₄ (in the case of cyclic) to C₂₅, typically C₂ to C₁₂, which may be substituted or unsubstituted, and which may include substituents. As a non-limiting example, the alkylene groups can be lower alkyl radicals having from 1 to 12 carbon atoms. As a non-limiting illustration, “propylene” is intended to include both n-propylene and isopropylene groups; and, likewise, “butylene” is intended to include both n-butylene, isobutylene, and t-butylene groups.

In an embodiment of the invention, the dialkyl maleate or dialkyl fumarate can have a structure according to formula (II):
R⁵—O—C(O)—CH═CH—C(O)—O—R⁴ (II)
where each occurrence of R⁴ and R⁵ are identical or different and represent organic groups which are inert to isocyanate groups at a temperature of 100° C. or less. In a particular embodiment of the invention, R⁴ and R⁵ are independently selected from C₁-C₆ linear, branched, and cyclic alkyl. In a more particular embodiment, R⁴ and R⁵ are selected from methyl, ethyl and propyl.

In a particular embodiment of the invention, the reaction product of an N-(-3-trialkoxysilylalkyl)amine and a dialkyl maleate or dialkyl fumarate can be an aspartate mixture that includes a polyoxyalklylene polyaspartate corresponding to formula (III) 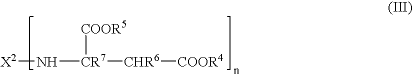
where
X² represents the residue obtained by removing the amino groups from a polyoxyalkylene polyamine having a functionality of n,
R⁴ and R⁵ are as defined above,
R⁶ and R⁷ are identical or different and represent hydrogen or organic groups which are inert towards isocyanate groups at a temperature of 100° C. or less and
n is2to4.

As used herein, the term “oxyalkylene” refers to an alkylene group containing one or more oxygen atoms. The term “aralkylene” refers to a divalent aromatic group, which may be ring-substituted. The term “alkylene aryl” refers to any acyclic alkylene group containing at least one aryl group, as a non-limiting example, phenyl.

In an embodiment of the invention, the polyoxyalkylene polyamine can be prepared by aminating the corresponding polyether polyols in known manner. In an embodiment of the invention, the polyoxyalkylene polyamine can be those available under the trade name JEFFANMINE®, available from Huntsman Chemical Co., Austin, Tex.

In embodiments of the invention, each occurrence of R⁴ and R⁵ can be independently selected from C₁-C₁₂ linear, branched, and cyclic alkyl and each occurrence of R₆ and R⁷ can be independently selected from C₁-C₄ linear, branched, and cyclic alkyl. Additionally, the polyoxyalkylene can be polyoxypropylene or polyoxyethylene, which are derived from propylene oxide and ethylene oxide respectively.

In an embodiment of the invention, the dialkyl maleate or dialkyl fumarate or dialkyl fumarate is selected from maleate diesters, mixed maleate esters, fumarate diesters or mixed fumarate esters where the ester group is one or more selected from methyl ethyl, propyl, butyl, amyl, and 2-ethylhexyl. Further to this embodiment, the dialkyl maleate or dialkyl fumarate or dialkyl fumarate can be substituted by methyl in the 2- and/or 3-position. In a particular embodiment, the dialkyl maleate or dialkyl fumarate is selected from dimethyl maleate, diethyl maleate and dibutyl maleate.

In an embodiment of the invention, the polyisocyanate used to form the reaction product contains from 2 to 6 isocyanate groups and has a number average molecular weight of about 112 to 1,000, in some cases about 140 to 400. In a particular embodiment, the polyisocyanate has a structure according to formula IV:
OCN—R⁸—NCO (IV)
where R⁸ is selected from C₂ to C₂₄ linear, branched, and cyclic alkylene, arylene, and aralkylene, which may optionally contain one or more isocyanate groups.

Further embodiments of the invention provide that the suitable polyisocyanates for use as component a) in the compositions of the present invention are selected from monomeric polyisocyanates, polyisocyanate adducts and/or NCO prepolymers. The polyisocyanates can have an average functionality of at least 1.8, in some cases at least 1.9 and in other cases at least 2. Also, the polyisocyanates can have an average functionality of up to 6, in some cases up to 5, in other cases up to 4 and in some situations up to 3. The average functionality of the polyisocyanates can be any stated value or range between any value recited above.

In a particular embodiment of the invention, the polyisocyanate is selected from 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and -1,4-diisocyanate, 1-isocyanato-2-isocyanatomethyl cyclopentane, 1-isocyanato-3-isocyanatomethyl-3,5,5-trimethyl-cyclohexane (isophorone diisocyanate or IPDI), bis-(4-isocyanatocyclohexyl)-methane, 2,4′-dicyclohexyl-methane diisocyanate, 1,3- and 1,4-bis-(isocyanatomethyl)-cyclohexane, bis-(4-isocyanato-3-methyl-cyclohexyl)-methane, α,α,α′,α′-tetramethyl-1,3-diisocyanate, α,α,α′,α′-1,4-xylylene diisocyanate, 1-isocyanato-1-methyl-4(3)-isocyanatomethyl cyclohexane, 2,4-hexahydrotoluylene diisocyanate, 2,6-hexahydrotoluylene diisocyanate, 1,3-phenylene diisocyanate, 1,4-phenylene diisocyanate, 2,4-toluylene diisocyanate, 2,6-toluylene diisocyanate, 2,4-diphenyl-methane diisocyanate, 4,4′-diphenyl-methane diisocyanate, 1,5-diisocyanato naphthalene and mixtures thereof.

In an embodiment of the invention, the polyisocyanate used to prepare the adducts for use as component a) are those prepared from the preceding monomeric polyisocyanates and containing isocyanurate, uretdione, biuret, urethane, allophanate, iminooxadiazine dione, carbodiimide and/or oxadiazinetrione groups. The polyisocyanates adducts, which can have an NCO content of from 5 to 30% by weight, include:
1) Isocyanurate group-containing polyisocyanates which may be prepared as set forth in DE-PS 2,616,416, EP-OS 3,765, EP-OS 10,589, EP-OS 47,452, and U.S. Pat. Nos. 4,288,586 and 4,324,879. The isocyanato-isocyanurates generally have an average NCO functionality of 3 to 3.5 and an NCO content of 5 to 30%, in some cases 10 to 25% and in other cases 15 to 25% by weight.
2) Uretdione diisocyanates which can be prepared by oligomerizing a portion of the isocyanate groups of a diisocyanate in the presence of a suitable catalyst, e.g., a trialkyl phosphine catalyst, and which can be used in admixture with other aliphatic and/or cycloaliphatic polyisocyanates, particularly the isocyanurate group-containing polyisocyanates set forth under (1) above.
3) Biuret group-containing polyisocyanates which may be prepared according to the processes disclosed in U.S. Pat. Nos. 3,124,605; 3,358,010; 3,644,490; 3,862,973; 3,906,126; 3,903,127; 4,051,165; 4,147,714; or 4,220,749 by using co-reactants such as water, tertiary alcohols, primary and secondary monoamines, and primary and/or secondary diamines. These polyisocyanates can have an NCO content of 18 to 22% by weight and an average NCO functionality of from 3 to 3.5.
4) Urethane group-containing polyisocyanates which can be prepared in accordance with the process disclosed in U.S. Pat. No. 3,183,112, by reacting excess quantities of polyisocyanates, in some cases diisocyanates, with low molecular weight glycols and polyols having molecular weights of less than 400, such as trimethylol propane, glycerine, 1,2-dihydroxy propane and mixtures thereof. The urethane group-containing polyisocyanates can have an NCO content of 12 to 20% by weight and an (average) NCO functionality of 2.5 to 3.
5) Allophanate group-containing polyisocyanates which can be prepared according to the processes disclosed in U.S. Pat. Nos. 3,769,318, 4,160,080 and 4,177,342. The allophanate group-containing polyisocyanates can have an NCO content of from 12 to 21% by weight and an (average) NCO functionality of 2 to 4.5.
6) Isocyanurate and allophanate group-containing polyisocyanates which can be prepared in accordance with the processes set forth in U.S. Pat. Nos. 5,124,427, 5,208,334 and 5,235,018, the disclosures of which are herein incorporated by reference. Such polyisocyanates can contain these groups in a ratio of monoisocyanurate groups to mono-allophanate groups of about 10:1 to 1:10, in some cases about 5:1 to 1:7.
7) Iminooxadiazine dione and optionally isocyanurate group-containing polyisocyanates which can be prepared in the presence of special fluorine-containing catalysts as described in DE-A 19611849. These polyisocyanates generally have an average NCO functionality of 3 to 3.5 and an NCO content of 5 to 30%, in some cases 10 to 25% and in other cases 15 to 25% by weight.
8) Carbodiimide group-containing polyisocyanates which may be prepared by oligomerizing di- or polyisocyanates in the presence of known carbodiimidization catalysts as described in DE-PS 1,092,007, U.S. Pat. No. 3,152,162 and DE-OS 2,504,400, 2,537,685 and 2,552,350.
9) Polyisocyanates containing oxadiazinetrione groups and containing the reaction product of two moles of a diisocyanate and one mole of carbon dioxide.

In an embodiment of the invention, the polyol in b) of the two-component coating composition can be a polymeric polyol selected from polyester polyols, (meth)acrylic polyols, polyether polyols, and mixtures thereof.

Non-limiting examples of suitable polyester polyols include reaction products of polyhydric, preferably dihydric alcohols to which trihydric alcohols may be added and polybasic, preferably dibasic carboxylic acids. Instead of these polycarboxylic acids, the corresponding carboxylic acid anhydrides or polycarboxylic acid esters of lower alcohols or mixtures thereof may be used for preparing the polyesters. The polycarboxylic acids can be aliphatic, cycloaliphatic, aromatic and/or heterocyclic and they can be substituted, e.g., by halogen atoms, and/or unsaturated. Non-limiting examples of suitable polycarboxylic acids include succinic acid; adipic acid; suberic acid; azelaic acid; sebacic acid; phthalic acid; isophthalic acid; trimellitic acid; phthalic acid anhydride; tetrahydrophthalic acid anhydride; hexahydro-phthalic acid anhydride; tetrachlorophthalic acid anhydride; endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate. Non-limiting examples of suitable polyhydric alcohols include, e.g., ethylene glycol; propylene glycol-(1,2) and -(1,3); butylene glycol-(1,4) and -(1,3); hexanediol-(1,6); octanediol-(1,8); neopentyl glycol; cyclohexanedimethanol (1,4-bis-hydroxymethyl-cyclohexane); 2-methyl-1,3-propanediol; 2,2,4-trimethyl-1,3-pentanediol; triethylene glycol; tetraethylene glycol; polyethylene glycol; dipropylene glycol; polypropylene glycol; dibutylene glycol and polybutylene glycol, glycerine and trimethlyolpropane.

As used herein, the terms “(meth)acrylic” and “(meth)acrylate” are meant to include both acrylic and methacrylic acid derivatives, such as the corresponding alkyl and alkylol esters often referred to as acrylates and (meth)acrylates, which the term “(meth)acrylate” is meant to encompass.

Suitable (meth)acrylic polyols include those prepared by polymerizing suitable hydroxy functional (meth)acrylic esters using known polymerization techniques. Suitable hydroxy functional (meth)acrylic esters include, but are not limited to, hydroxy ethyl(meth)acrylate and hydroxypropyl(meth)acrylate. Additionally, other hydroxy functional polymerizable monomers can be copolymerized with the hydroxy functional (meth)acrylic esters. Non-limiting examples of such hydroxy functional polymerizable monomers include allyl alcohol and glycerol allyl ether.

Polymerizable alkyl and alkylol esters and vinylic monomers can be copolymerized to give a variety of hydroxy functional poly(meth)acrylic resins that can be used as (meth)acrylic polyols in the invention. Suitable (meth)acrylic alkyl esters that can be used include, but are not limited to, methyl(meth)acrylate, ethyl(meth)acrylate, butyl(meth)acrylate and dodecyl(meth)acrylate as well as the hydroxyl functional (meth)acrylates indicated above. Additionally, other vinylic comonomers may be used in preparing the hydroxy functional poly(meth)acrylic resins. These vinylic comonomers include, but are not limited to, styrene, alpha-methyl styrene, cinnamyl esters, diethyl maleate, vinyl acetate, allyl propionate and the like.

In an embodiment of the invention, the polymeric polyols, in many cases diols, have a number average molecular weight of at least 500, in some instances greater than 500, in some situations at least 1,000, in other situations at least 2,000, in certain instances at least 3,000, in some cases at least 6,000 and in other cases at least 8,000. Also, the number average molecular weight of the polymeric polyols can be up to 20,000, in some cases up to 15,000 and in other cases up to 12,000. The number average molecular weight of the polymeric polyols can vary and range between any of the values recited above.

Any suitable polyether polyol can be used in the present invention. Suitable methods for preparing polyether polyols are known and include the KOH process as is well known in the art as well as those described, for example, in EP-A 283 148 and U.S. Pat. Nos. 3,278,457, 3,427,256, 3,829,505, 4,472,560, 3,278,458, 3,427,334, 3,941,849, 4,721,818, 3,278,459, 3,427,335, and 4,355,188.

In one embodiment of the invention, the polyether polyols used in the invention can include unsaturated groups in the polyether molecule.

In another embodiment of the invention, the polyethers have a maximum total degree of unsaturation of 0.1 milliequivalents/g (meq/g) or less, in some cases less than 0.04 (meq/g) in other cases less than 0.02 meq/g, in some situations less than 0.01 meq:/g, in other situations 0.007 meq/g or less, and in particular situations 0.005 meq/g or less. The amount of unsaturation will vary depending on the method used to prepare the polyether as well as the molecular weight of the polyether. Such polyether diols are known and can be produced by, as a non-limiting example, the propoxylation of suitable starter molecules. As another non-limiting example, minor amounts (up to 20% by weight, based on the weight of the polyol) of ethylene oxide can be used. If ethylene oxide is used, it is preferably used as the initiator or to cap the polypropylene oxide groups. Non-limiting examples of suitable starter molecules include diols such as ethylene glycol, propylene glycol, 1,3-butanediol, 1,4-butanediol, 1,6 hexanediol and 2-ethylhexanediol-1,3. Also suitable are polyethylene glycols and polypropylene glycols.

In an embodiment of the invention, in addition to the above-described polymeric polyols, component b) can include up to 20%, in some cases up to 15%, and in other cases up to 10% by weight, based on the weight of all of the polyols in b) of low molecular weight polyhydric (in some cases dihydric and trihydric) alcohols having a molecular weight of 32 to 500 in some cases 32 to 499. Non-limiting examples of suitable low molecular weight polyols include ethylene glycol, 1,3-butandiol, 1,4-butandiol, 1,6-hexandiol, glycerine, trimethylolpropane, pentaerythritol and mixtures thereof.

In the present invention, second component b) includes a polyol and a catalyst. Any suitable catalyst for effecting the reaction of hydroxyl groups and isocyanate groups can be used in the present invention. Suitable catalysts include, but are not limited to, zinc octoate, tin(II) octoate, dibutyl tin dilaurate; tin octoate, dibutyltin diacetate, dimethyltin dimercaptide, bismuth catalysts, tertiary amine catalysts such as N,N-dimethylbenzylamine, N-methyl morpholine, and DABCO® 1027 available from Air Products, and mixtures thereof.

In an embodiment of the invention, the catalyst is present in component b) at a level of at least 0.01, in some cases at least 0.1, in other cases at least 0.5 and in some situations at least 1.0 percent by weight of the two-component composition. Also, the catalyst can present in component b) at a level of up to 10, in some cases up to 8, in other cases up to 6, in some situations up to 4 and in other situations up to 3 percent by weight of the two-component composition. The catalyst is present at a level where it is able to promote the reaction of hydroxyl groups and isocyanate groups at the desired cure temperature but not so high as to make component b) unstable or to promote too fast a cure. The catalyst can present in component b) at any stated level or can range between any level recited above.

The two-corriponent coating compositions of the present invention may be prepared by mixing the individual components. Components a) and b) are present in an amount sufficient to provide an equivalent ratio of isocyanate groups to hydroxyl groups of at least 0.8:1, in some cases 0.9:1, and in other cases at least 0.95:1. In embodiments of the invention, the equivalent ratio of isocyanate groups to hydroxyl groups is about 1:1. In other embodiments, the equivalent ratio of isocyanate groups to hydroxyl groups is up to 1.2:1, in some cases up to 1.1:1 and in other cases up to 1.05:1. The amount of components a) and b) and the equivalent ratio of isocyanate groups to hydroxyl groups can be any stated value or range between any of the values recited above.

The two-component compositions generally may be either solvent-free or contain up to 70%, in some cases up to 60% organic solvents, based on the weight of components a) and b). Suitable organic solvents include those which are known from polyurethane chemistry. Non-limiting examples of suitable solvents that can be used in the present invention include ethyl acetate, butyl acetate, methylethyl ketone, methylisobutyl ketone, ethylene glycol monoethylether acetate, methoxypropyl acetate, toluene, xylene, white spirit and mixtures thereof.

The present compositions can also contain, as part of either component a) or component b), known additives, such as leveling agents, wetting agents, flow control agents, antiskinning agents, antifoaming agents, fillers (such as silica, aluminum silicates and high-boiling waxes), viscosity regulators, plasticizers, pigments, dyes, UV absorbers, light stabilizers, and stabilizers against thermal and oxidative degradation.

Non-limiting examples of plasticizers include tricresyl phosphate, phthalic acid diesters, chloroparaffins and mixtures thereof. Non-limiting examples of pigments and fillers include titanium dioxide, barium sulfate, chalk and carbon black. Non-limiting examples of stabilizers include substituted phenols.

Non-limiting examples of light stabilizers include the sterically hindered amines described, for example, in U.S. Pat. Nos. 4,123,418, 4,110,304, 3,993,655, and 4,221,701. In an embodiment of the invention, the light stabilizers are selected from bis-(1,2,2,6,6-penta-methylpiperid-4-yl)-sebacate, bis-(2,2,6,6-tetramethylpiperid-4-yl)-sebacate, and n-butyl-(3,5-ditert.butyl-4-hydroxybenzyl)-malonic acid bis-(1,2,2,6,6-pentamethylpiperid-4-yl)-ester and mixtures thereof.

Embodiments of the present invention provide a method of coating a substrate that includes applying the above-described two-component compositions to at least a portion of a surface of a substrate. The two-component compositions can be applied to any desired substrates, such as wood, plastics, leather, paper, textiles, glass, ceramics, plaster, masonry, metals and concrete. They can be applied by standard methods, such as spray coating, spread coating, flood coating, casting, dip coating, roll coating. The coating compositions may be clear or pigmented.

In an embodiment of the invention, the two-component composition is used to coat metal substrates.

The two-component compositions can be cured at ambient temperature or at elevated temperatures. In an embodiment of the invention, the two-component compositions are cured at ambient temperatures. In other embodiments, heat is applied during curing such that the temperature is from 60° to 120° C., in some cases 80° to 100° C.

Depending on the specific two-component composition and the cure temperature, the two-component coating composition is cured for a period of from 20 minutes to 30 days, in some cases from 20 minutes to 10 days, in other cases from 20 minutes to 24 hours, in some situations from 20 minutes to 12 hours, in other situations from 20 minutes to 6 hours and in certain situations from 20 minutes to 4 hours.

The invention is further illustrated but is not intended to be limited by the following examples in which all parts and percentages are by weight unless otherwise specified.

### EXAMPLE 1

The example demonstrates the preparation of a silane functional aspartate according to the invention. The aspartate resin was prepared according to U.S. Pat. No. 4,364,955 to Kramer et al. To a 5-liter flask, fitted with agitator, thermocouple, nitrogen inlet, addition funnel and condenser was added 1483 g (8.27 equivalents (eq.)) of 3-aminopropyl-trimethoxysilane followed by 1423.2 (8.27 eq.) diethyl maleate over a two hour period at 25° C., and held at that temperature for five hours. The unsaturation number, determined by iodine titration, was 0.6, indicating that the reaction was approximately 99% complete. The viscosity was 11 cps measured using a Brookfield® Digital Viscometer, Model DV-II+, Brookfield Engineering, Inc., Middleboro, Mass., spindle 52,100 rpm at 25° C.

### EXAMPLE 2

This example describes the preparation of a silane functional polyisocyanate according to the invention. To a 3-liter, round bottom flask equipped with an agitator, nitrogen inlet, addition funnel, and condenser was added 982 g (5.1 eq.) of 100% solids hexamethylene diisocyanate homopolymer with viscosity of 3,000 cps at 25° C. and 21.5% NCO available as Desmodur® N3300 from Bayer Polymers LLC, Pittsburgh, Pa. (polyisocyanate 1) and 400 g n-butyl acetate. The silane functional aspartate of Example 1 (438 g, 1.2 eq.) was added over 90 minutes such that the temperature could be maintained below 30° C. The reaction mixture was then held for 90 minutes at 60° C. The NCO contents was titrated to be 6.38% (theoretical 7.1) and viscosity was 710 cps at 25° C.

### EXAMPLE 3

This example describes the preparation of a silane functional polyisocyanate according to the invention. To a 3-liter round bottom flask, as in Example 2, was added 1162 (6 eq.) of polyisocyanate 1. The silane functional aspartate of Example 1 (438 g, 1.2 eq.) was added over 90 minutes such that the temperature could be maintained below 30° C. The reaction mixture was then held for 90 minutes at 60° C. The NCO content was titrated to be 9.91% (theoretical 10.08) and viscosity was 420 cps at 25° C. using a Wells-Brookfield® Cone/Plate Viscometer, available from Brookfield Engineering, Inc.

### EXAMPLE 4

This example described the preparation of coating films according to the invention. The polyisocyanates of Examples 2 and 3 were combined with a hydroxyl functional polyacrylate resin (70 wt. % solids in n-butyl acetate) available as Desmophen® A LS 2009/1 from Bayer Polymers LLC (polyacrylate 1) at an NCO to OH equivalent ration of 1.1 to 1. The resulting formulation was adjusted to 65 wt. % solids with n-butyl acetate. Dibutyltin dilaurate (0.03 parts per 100 parts resin) as a 10 wt. % solution in n-butyl acetate was used as catalyst. A polyether modified poly dimethyl siloxane (BYK®-300, available from Byk Chemie USA Inc. Wallingford, Conn.) was used as flow control agent at 0.02 parts per 100 parts resin as a 10 wt. % resin in n-butyl acetate. The coatings are described in the table below.

Coating films were applied using a Bird Applicator (Byk-Gardner USA, Columbia, Md.) on an e-coated panel (ACT Laboratories, Inc., Hillsdale, Md.) at a 5 mil (125 μm) film thickness. The film was allowed to set at ambient laboratory conditions for one month.

Initial gloss measurements were made at 20° and 60° using a Gloss Meter (Byk-Gardner). The reported numbers are the average of readings taken at the top, middle and bottom of the panel. BON AMI® cleanser (Bon Ami Company, Kansas City, Mo.) was sprinkled on the panel and excess cleanser tapped off. The cleanser coated panel was exposed to 10 double rubs of the foam padded foot of a CROCKMETER® (Model CM5-1093, Atlas Electric Devices Co., Chicago, Ill.). After the abrasion treatment, the panel was cleaned with water, dried and 20° and 60° gloss measurements repeated. Scratch resistance is reported as the percent of initial gloss retained as shown in the table below.

Pencil hardness was determined using a standard set of pencils with varying ‘H’ (hardness) and ‘B’ (blackness) values. A pencil is selected and a line about ½-inch long is made. If the pencil scratches the surface of the coating, then a softer grade pencil is used until the pencil does not scratch the coating.

The methyl ethyl ketone (MEK) double rubs were measured as follows. The ball of a 2 lb ball pien hammer was securely wrapped with several layers of cloth (8″×8″ cloth folded twice) and secured using a rubber band. The cloth was saturated with MEK. The wet ball pien hammer was laid on the coating surface, so that the ball pien is at a 90° angle to the surface. Without applying downward pressure, the hammer is pushed back and forth over an approximately 4″ long area of the coating. One forward and back motion was counted as 1 double rub. The cloth was resaturated with MEK after every 25 double rubs.

| Formulation | 1 | 2 | 3 | 4 | 5 |
|---|---|---|---|---|---|
| Polyacrylate 1 | 20 | 24.3 | 26.58 | 27.92 | 23.4 |
| Polyisocyanate 1 | — | — | 6.96 | 6.48 | 8.54 |
| Polyisocyanate of | 23.13 | — | 8.66 | — | — |
| Example 2 | | | | | |
| Polyisocyanate of | — | 19.36 | — | 8.1 | — |
| Example 3 | | | | | |
| Catalyst | 0.1 | 0.1 | 0.1 | 0.1 | 0.08 |
| Flow Control | 0.06 | 0.06 | 0.06 | 0.06 | 0.05 |
| Agent | | | | | |
| n-butyl acetate | 6.88 | 6.34 | 7.79 | 7.5 | 6.40 |
| Performance | | | | | |
| Results | | | | | |
| Pencil Hardness | 106 | 175 | 175 | 180 | 175 |
| (sec) | | | | | |
| Pencil Hardness | F | H | 2H | 3H | H |
| MEK double rubs | 85 | 90 | 100+ | 100+ | 100+ |
| Initial Gloss | | | | | |
| 60° | 81.2 | 84.1 | 91.9 | 92.1 | 93.8 |
| 20° | 65.4 | 68.9 | 86.5 | 88.5 | 90.1 |
| Gloss after | | | | | |
| abrasion | | | | | |
| 60° | 76.2 | 75.8 | 84.6 | 84.6 | 79.7 |
| 20° | 51.1 | 52.9 | 69.8 | 69.1 | 61.6 |
| Gloss retained (%) | | | | | |
| 60° | 94 | 90 | 92 | 92 | 85 |
| 20° | 78 | 77 | 81 | 78 | 68 |

The data demonstrate the excellent scratch resistance of the coatings prepared according to the present invention.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A two-component coating composition comprising:
(a) a first component comprising a compound that contains trialkoxysilyl and isocyanate functional groups; and
(b) a second component comprising a polyol and a catalyst.

2. The composition of claim 1, wherein the compound that contains trialkoxysilyl and isocyanate functional groups is the reaction product of a polyisocyanate and the reaction product of an N-(-3-trialkoxysilylalkyl)amine and a dialkyl maleate or dialkyl fumarate or dialkyl fumarate.

3. The composition of claim 2, wherein the N-(-3-trialkoxysilylalkyl)amine has a structure according to formula (I):
NH₂—R¹—Si(—O—R²)₃ (I)
wherein R¹ is selected from C₁-C₁₂ linear, branched and cyclic alkylene, arylene, and aralkylene; and R² is independently selected from C₁-C₆ linear, branched, and cyclic alkyl.

4. The composition of claim 2, wherein the dialkyl maleate or dialkyl fumarate or dialkyl fumarate has a structure according to formula (II):
R⁵—O—C(O)—CH═CH—C(O)—O—R⁴ (II)
wherein R⁴ and R⁵ are identical or different and represent organic groups which are inert to isocyanate groups at a temperature of 100° C. or less.

5. The composition of claim 2, wherein the reaction product is an aspartate mixture comprising:
a polyoxypropylene polyaspartate corresponding to the formula 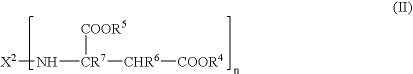
wherein
x² represents the residue obtained by removing the amino groups from a polyoxyalkylene polyamine having a functionality of n,
R⁴ and R⁵ are identical or different and represent organic groups which are inert to isocyanate groups at a temperature of 100° C. or less,
R⁶ and R⁷ are identical or different and represent hydrogen or organic groups which are inert towards isocyanate groups at a temperature of 100° C. or less and
n is 2to4.

6. The composition of claim 5, wherein each occurrence of R⁴ and R⁵ are independently selected from C1-C₁₂ linear, branched, and cyclic alkyl and each occurrence of R⁶ and R⁷ is independently selected from C₁-C₄ linear, branched, and cyclic alkyl.

7. The composition of claim 2, wherein the dialkyl maleate or dialkyl fumarate or dialkyl fumarate is selected from maleate diesters, mixed maleate esters, fumarate diesters or mixed fumarate esters where the ester group is one or more selected from the group consisting of methyl ethyl, propyl, butyl, amyl and 2-ethylhexyl.

8. The composition of claim 6, wherein the dialkyl maleate or dialkyl fumarate or dialkyl fumarate is substituted by methyl in the 2- and/or 3-position.

9. The composition of claim 7, wherein the dialkyl maleate or dialkyl fumarate is selected from dimethyl maleate, diethyl maleate and dibutyl maleate.

10. The composition of claim 2, wherein the polyisocyanate contains from 2 to 6 isocyanate groups.

11. The composition of claim 2, wherein the polyisocyanate has a structure according to formula (III):
OCN—R⁸—NCO (III)
wherein R⁸ is selected from C₂ to C₂₄ linear, branched, and cyclic alkylene, arylene, and aralkylene, which may optionally contain one or more isocyanate groups.

12. The composition of claim 1, wherein the polyol is selected from the group consisting of polyester polyols, (meth)acrylic polyols, polyether polyols, and mixtures thereof.

13. The composition of claim 1, further comprising one or more materials selected from the group consisting of leveling agents, wetting agents, flow control agents, antiskinning agents, antifoaming agents, fillers viscosity regulators, plasticizers, pigments, dyes, UV absorbers, thermal stabilizers, antioxidants, and mixtures thereof.

14. The composition of claim 3, wherein R¹ is selected from ethylene, propylene, and butylene; and R² is selected from ethyl and propyl.

15. The composition of claim 4, wherein R³ is selected from methyl, ethyl and propyl.

16. The composition of claim 2, wherein the polyisocyanate is selected from the group consisting of 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and -1,4-diisocyanate, 1-isocyanato-2-isocyanatomethyl cyclopentane, 1-isocyanato-3-isocyanatomethyl-3,5,5-trimethyl-cyclohexane (isophorone diisocyanate or IPDI), bis-(4-isocyanatocyclohexyl)-methane, 2,4′-dicyclohexyl-methane diisocyanate, 1,3- and 1,4-bis-(isocyanatomethyl)-cyclohexane, bis-(4-isocyanato-3-methyl-cyclohexyl)-methane, α,α,α′,α′-tetramethyl-1,3-diisocyanate, α,α,α′,α′-1,4-xylylene diisocyanate, 1-isocyanato-1-methyl-4(3)-isocyanatomethyl cyclohexane, 2,4-hexahydrotoluylene diisocyanate, 2,6-hexahydrotoluylene diisocyanate, 1,3-phenylene diisocyanate, 1,4-phenylene diisocyanate, 2,4-toluylene diisocyanate, 2,6-toluylene diisocyanate, 2,4-diphenyl-methane diisocyanate, 4,4′-diphenyl-methane diisocyanate, 1,5-diisocyanato naphthalene and mixtures thereof.

17. A substrate coated with the composition of claim 1.

18. A metal substrate coated with the composition of claim 1.

19. A method of coating a substrate comprising applying the composition of claim 1 to at least a portion of a surface of the substrate.

20. A coated substrate prepared according to the method of claim 19.

21. The composition of claim 1, wherein the polyol includes up to 20% by weight of low molecular weight polyhydric alcohols having a molecular weight of from 32 to 500.

22. The composition of claim 21, wherein the polyhydric alcohols are selected from the group consisting of ethylene glycol, 1,3-butandiol, 1,4-butandiol, 1,6-hexandiol, glycerine, trimethylolpropane, pentaerythritol and mixtures thereof.

23. The composition of claim 1, wherein the catalyst is selected from the group consisting of zinc octoate, tin(II) octoate, dibutyl tin dilaurate; tin octoate, dibutyltin diacetate, dimethyltin dimercaptide, bismuth catalysts, tertiary amine catalysts and mixtures thereof.

24. The composition of claim 21, wherein the polyol includes polymeric polyols having a number average molecular weight of from greater than 500 up to 20,000.

25. The composition of claim 1, wherein the polyol includes polymeric polyols having a number average molecular weight of from 500 to 20,000.
